(19) United States
(12) Patent Application Publication
(10) Pub. No.: US 2015/0211445 A1
(43) Pub. Date: Jul. 30, 2015

(54) MISSILE HAVING A TURBINE-COMPRESSING MEANS-UNIT

(71) Applicants: Guido Kurth, Wasserburg (DE); Christoph Bauer, Steinhoring (DE)

(72) Inventors: Guido Kurth, Wasserburg (DE); Christoph Bauer, Steinhoring (DE)

(73) Assignee: Bayern-Chemie Gesellschaft fur Flugchemische Antriebe mbH, Aschau am Inn (DE)

(21) Appl. No.: 14/607,894

(22) Filed: Jan. 28, 2015

(30) Foreign Application Priority Data
Jan. 29, 2014 (DE) 102014000991.2

(51) Int. Cl. F02K 9/42; F02K 3/00; F42B 15/10

(52) U.S. Cl. CPC F02K 9/42; F42B 15/10; F02K 3/00

(57) ABSTRACT

Missile having a jet engine (2) comprising at least one turbine (3) and at least one compressing means (4), wherein gas generated in at least one gas generator (7) of the missile (1) drives a turbine (3). The compressing means (4) and the turbine (3) are arranged opposite to the flight direction (6) adjacent to each other.

The invention relates to a missile with a jet engine, comprising at least one turbine and at least one compressing means, wherein gas produced in at least one gas generator of the missile drives a turbine.

From DE 29 437 30 C2 a ram jet engine, in particular a solid fuel engine is known comprising a gas generator for generating a fuel-rich fuel gas stream. Furthermore, a thrust chamber is provided, in which the fuel gas with addition of ram air is combusted generating thrust.

The missile according to the invention represents a drive concept for tactical missiles which combines the advantages of a turbo jet engine with the advantages of a solid rocket motor (SRM), but avoids the disadvantages associated with the conventional concepts.

Moreover, the concept according to the invention combines the advantages of a turbo jet engine with the advantages of a solid fuel ram jet engine. Solid fuel ram jet enginess are e.g. used at METEOR-missiles as so-called controllable solid fuel ram jet engines (throttleable ducted rocket) (TDR). To this extent the disadvantages of conventional concepts are avoided.

SRM-powered missiles have only a very limited range. A very short acceleration phase is followed by a longer ballistic gliding flight. Due to the decreasing flight-mach number during the gliding flight, a reduced maneuverability occurs.

This disadvantage can be at least partially compensated by usage of a so-called double- or two-pulse engine. The range of applications of the SRM-missile is, therefore, strongly limited. It focusses on short- and medium-range applications with greatly reduced requirements for the maneuverability. The greatly reduced requirements pertain also to the driven cruise, the thrust variants or the ability to circle for a longer time waiting in the airspace.

Turbine-powered engines, so-called TJ-engines, have, together with the SRM-engines, the common property of being capable to raise off ground. However, they comprise the ability to cover long-range missions with a very wide variation of thrust.

In contrast to the SRM-engine, the TJ-drive systems, however, are very complex and have a higher weight.

The shelf life of the TJ-engine is, furthermore, limited since in fully fueled systems in the context of a significant lifetime requirement (being maintenance-free over the period of several years) leaks in the tank- and fuel delivery system may occur. For this reason, the inspection intervals and maintenance intervals, respectively, are greatly reduced.

Another disadvantage of the TJ-engine is that the flight operations as well as the range of mach numbers is limited to a subsonic or moderate supersonic operation, respectively. A back fitting of the missile to the higher supersonic region has a negative effect on the degree of complexity of the drive.

In particular, with strong maneuvers which require very high acceleration values, the so-called flame-out-effect may occur, that can lead to a total failure of the engine.

If higher flight-mach numbers are required, usually only ram jet drives are considered, as for example, liquid ram drives or TDR-systems. Both drive concepts, however, comprise the disadvantage that they are functional and delivering thrust only at flight mach numbers around mach 1.9.

Both engine types are, therefore, despite a high controllability of thrust, in particular for the new asymmetric designed scenarios, useless. The two last-mentioned drive systems (liquid ram jet engine and TDR-systems) do not have the ability to fly above or in a certain (urban) area with a low airspeed.

Both drive systems require an additional booster engine (booster), to bring the missile to the necessary minimum operational flight mach number. The liquid ram jet drive can, due to its physical frame conditions, similar to the TJ-drive cause the flame-out effect in demanding maneuvers.

The engine systems known in the prior art prove furthermore to be disadvantageous because—if available—due to the linear arrangement of compressing means and turbine, in between which the after-burner chamber is arranged, the engines of the missiles are often disproportionately long. The great length of the missile can cause a significant loss of range.

The often used centrifugal compressors require a technically highly complex supply of hot gas from the gas generator to the turbine. The gas conduit pipes used have several bends making possible only a use of low energy particle-free combustion gases resulting in a significant reduction of the performance.

With the present invention, the aforementioned significant disadvantages shall be eliminated.

The invention also has the object to provide a missile, the jet engine of which has a compact structure. A further object is to design a jet engine in such a way that in the gas generator of the engine high energy particle-loaded solid fuels can be used for gas production. In addition, the invention has the object to reduce the complexity of the structure of the jet engine and to concurrently reduce thereby the production costs.

The problem is solved by a missile with a jet engine comprising at least one turbine and at least one compressing means in which gas produced in at least one gas generator of the missile drives a turbine, wherein, opposite to the direction of flight and in the direction of gas flow, respectively, the compressing means and the turbine are arranged adjacent to each other.

Advantageous embodiments are described in the sub-claims.

The missile according to the invention is advantageous in that it fulfills the shelf life and the maintainability of the SRM-drive. It additionally combines the shelf life and the maintainability of the SRM-drive with the general thermodynamic cycle of a TJ- or TDR-drive, respectively, such that an ability to raise off ground of the air breathing system is possible without an additional booster. At the same time, another flight mach number range can be maintained even at a high maneuverability.

The missile according to the invention or the engine according to the invention, respectively, achieves this by a compact turbo unit. This turbo unit is, in contrast to a conventional design, positioned as a turbine-compressing means-unit in a parallel arrangement between the gas generator and a gas conduit pipe of the TDR-system and the after-burner chamber.

In an advantageous manner, the gas generator generates under-balanced fuel gas, which is applied as the working medium to the turbine. The turbine then directly drives via a shaft the parallel arranged compressing means-unit. Movable parts are arranged as separate disks which are located between stators. Due to the high temperature of the exhaust gases of the gas generator, the turbine is designed so that the turbine blades are not arranged on a central hub. Moreover, the turbine blades are connected fixedly with the structure connecting the turbine impeller with the compressing means impeller.

In this way, high centrifugal forces can be avoided. The turbine blades must only receive compressive forces.

The hot gas generated in the gas generator of the missile is fed to a turbine in which the flow energy of the hot gas is converted into a rotational movement of the turbine. The turbine drives the compressing means and other aggretages, for example at least one auxiliary generator or at least one hydraulic pump. The jet engine draws in ambient air which is led for an increase of pressure into the compressing means being driven by the turbine and which is compressed there. The compressed air is supplied to an after-burner chamber and fuel, generally kerosene, is injected tereto. For generating the drive thrust, the fuel-air-mixture is combusted in the after-burner chamber and fed to the jet-nozzle of the missile for generating the recoil.

According to the invention, the jet engine of the missile comprises a gas generator in which fuel, in particular a solid fuel, is converted into drive gas which powers the turbine. In the case of a catalytic decomposition of fuel, a cold or chilly drive is present.

In comparison thereto, a hot drive is to be distinguished, in which instead of the decomposition of the solid fuel, a part of the fuel is combusted for driving e.g. a turbo pump. The conversion of solid fuel into gas can take place in a ram jet combustion chamber. The gas generator can comprise a under-balanced and/or a boron-containing solid fuel which is combusted in the gas generator for generating a particle-loaded gas flow.

The combustion rate of the solid fuel is pressure-dependent. By way of example and in no way exclusively, a combustion temperature T_{GG} of 1.500 to 1.800 K may be present. The particle content may be 60% with a GG-pressure p_{GG} of 4 to 90 bar.

A gas conduit pipe supplies the gas generated in the gas generator to the turbine. The gas conduit pipe is preferably positioned centrally in the missile so that the drive gas blows directly on the downstream, in a turbine casing arranged turbine, which is preferably connected in parallel with the compressor and preferably connected fixedly thereto.

Instead of a gas conduit pipe, also other technical means fulfilling the function of supplying the generated gas to the turbine can be used.

A turbine-compressing means-unit (turbo-unit) is designed in two stages and comprises the turbine and the compressing means. In the turbine-compressing means-unit, a drive shaft is provided via which the turbine which is brought into rotation around its own axis by the generated gas, drives the compressor. The energy transfer from the turbine to the compressor is effected by an impulse so that no significant pressure reduction is created. By the pressure and the velocity of the hot gas flowing through the gas conduit pipe, an impulse is applied on the blades of the turbine. By means of the impulse, a torque is created at a shaft which can be used, for example, to drive a compressing means.

By means of the drive connection of the turbine with the compressing means in the turbine-compressing means-unit, a two-stage compression of the supplied air by means of an axial compressor is existent. The two-stage property of the turbine-compressing means-unit is explained by the fact that by the hot gas of the gas generator, first the at least one impeller of the turbine is driven. Opposite to the direction of flight therebehind in a second stage, the at least one impeller of the compressor is driven. In between the housing intermediate walls are arranged which do not rotate. The gas changes, as it passes through, the direction in order to optimally perform work again at the next impeller. Turbines with several impellers are called multi-staged. Mult-stage turbines can be formed conically.

The two-stage form of the turbine-compressing means-unit is illustrative only and in no way meant exclusively. In particular, for smaller jet engines, the compressing means/compressor may be configured as a single-stage centrifugal compressor.

It is conceivable that a compressing means/compressor comprises a plurality of compressor stages. Here, impellers comprising a plurality of compressor blades are arranged axially one behind the other. The same shall apply mutatis mutandis to a turbine having a plurality of turbine blades.

The transmission of the rotational speed from the turbine to the compressor is controlled indirectly via a gas mass flow or directly via an adjustable nozzle. For supplying air to the compressing means, the turbine-compressing means-unit comprises on the outside of the missile an air inlet comprising, opposite to the housing of the missile, an annular gap.

The turbine-compressing means-unit is disposed in a turbine housing comprising the turbine and the compressing means. The turbine housing comprises at least one housing wall surrounding the turbine and the compressing means. Additional intermediate housing walls effect a radial division of the turbine housing into a region accomodating the turbine and a further region in which the compressor is disposed.

The jet engine according to the invention has an extremely advantageous effect on the compact design of the missile since the housing of the turbine-compressing means-unit accomodates and surrounds both the turbine and the compressing means preferably in a common housing. The previously required space for the respective additional separate turbine- and compressor housing, respectively, is becoming empty and may be used for other purposes.

In the direction of flow, the turbine is arranged in the turbine housing behind the gas generator and the gas conduit pipe. The turbine is rotated around its own axis by the hot gas entering from the gas generator into the gas conduit pipe and it is driven in this manner.

The turbine drives the compressor via a shaft. It is, moreover, conceivable that the jet engine comprises two or more turbines driving a multi-stage compressing means by means of at least one shaft.

In one-stream-engines , the biggest part of the kinetic energy from the gas generated in the gas generator is usable for the recoil of the missile.

Preferably, only as much energy is transmitted to the turbine as is required for the operation of the compressing means.

The compressor comprises a two-stage axial compressor compressing air provided by the air inlet in an outer annular gap. The turbine which is arranged on a central hub is driven by the hot gas jet of the gas generator and drives in turn the compressor. In comparison to a conventional design of a turbo engine, in this way no retroactive effect of the compressor operating point to the turbine is existing. This leads to an immediate generation of thrust by the after-burning taking place in the ram jet combustion chamber.

Furthermore, purely by way of example and not exclusively, the use of a single turbine being arranged in the turbine housing and being downstream of the gas conduit pipe is assumed.

The turbine and the compressing means are connected in parallel. The turbine and the compressing means are connected in parallel.

The turbine drives the compressing means which is arranged parallel to the turbine preferably directly. For this purpose, the movable parts of the turbine are formed as separate disks which are situated between stators of the turbine housing.

Due to the extremely high temperature of the hot gases generated in the gas generator, the turbine blades are preferably not arranged on a central hub but fixedly connected to a structure with which at least one turbine impeller is connected to at least one impeller of the compressor. The turbine blades receive essentially only compressing forces so that a damage by the centrifugal forces acting on the turbine blades is avoided. The hot gas supplied from the gas generator expands in the turbine.

The turbine and the compressing means preferably form a spatial turbine-compressing means-unit, which is preferably arranged in the turbine housing. To form the turbine-compressing means-unit, the turbine and the compressing means are preferably and in particular preferably arranged immediately adjacent to each other. In this respect, any constructive-geometrical configuration is conceivable. In particular, the turbine can be placed opposite to the direction of flight axially in front of the compressor. It is also conceivable that the compressing means is positioned opposite to the direction of flight in front of the turbine. Hereby, the turbine and the compressing means extend parallel to each other.

The energy for driving the turbine-compressing means-unit is preferably attained solely from the kinetic energy of the hot gas which accounts for only about 2% of the total energy content of the hot gas which is chemically converted only in the after-burner chamber.

Depending on size and perimeter of the missile, the turbine-compressing means-unit can be arranged in the front region or in the rear region of the missile. It is also conceivable to arrange the turbine-compressing means-unit centrally about in the central region of the missile.

Within the turbine-compressing means-unit, the turbine and the compressing means are arranged on a common drive shaft.

The compressing means can be illustrative and not exclusively a compressor.

The compressing means supplies the supplied ambient air with kinetic energy which is converted into pressure energy.

The compressing means receives ambient air from a supersonic air inlet and compresses the air supplied to it in dependency of the rotational speed of the shaft which is transmitted from the turbine to the compressing means/compressor.

It is a task of the compressing means to supply the after-burner chamber with compressed ambient air. Thereby, the compressing means receives air which has been already pre-compressed in the air inlet. The total pressure of the air which is already pre-compressed in the air inlet is increased further in the compressor.

By supplying pre-compressed air to the compressing means, the physical stability of the compressing means is additionally increased. The amount of fuel which can be supplied to the after-burner chamber increases with an increase of the pressure of the compressed air contained in the after-burner chamber. Therefore, the supply of pre-compressed air results in an improved bandwidth of thrust and thus in a broader fuel injection spectrum.

It particular at high speeds the air intake has an important function. The inflowing air dams at air baffles inside the air inlet and is decelerated and pre-compressed by it. This is particularly necessary in supersonic flight, since the air flowing into the air inlet has to be decelerated to subsonic speed before entering the compressing means. If the pre-compressed air would enter the compressing means with supersonic speed, damages inside the compressing means and in the compressor blades could be caused.

In the present invention, the compression of air takes place decoupled from the turbine essentially by means of the compressing means. The turbine itself is driven by the gas generated in the gas generator. It follows that the jet engine of the missile may be ramped up in a much shorter time than it is possible with jet engines from the prior art in which the turbine is driven by gas which is generated in the after-burner chamber. Complex interdependencies and feedbacks between the turbine and the compressing means can be omitted.

An air inlet is provided supplying ambient air to the compressor. The air inlet is, with respect to the missile, open to the front. The air intake acts as a diffusor for the conversion of the kinetic energy of the inflowing air for increasing the pressure and the temperature of the supplied air.

The air inlet is arranged in the region of the central section of the missile and causes a pre-compression of the supplied ambient air by external compression. The pre-compressed air is supplied to the compressing means/compressor which further compresses the air. The double-compressed air is supplied into the after-burner chamber and is there mixed with fuel and ignited for generating the thrust required for the recoil of the missile.

The amount of hot gas (gas mass flow) required for driving the turbine is controllable by a valve in the entrance of the gas conduit pipe. In this way, the performance of the turbine can be controlled according to the required thrust. With the control of the power of the turbine—regardless of the mentioned decoupling of the compression of air—likewise the performance of the compressor and hence the pressure in the after-burner chamber is controllable. The pressure in the after-burner chamber designates the amount of fuel which can be introduced into the after-burner chamber. Thus, the thrust of the missile can be specifically controlled.

The air inlet is arranged at the missile housing in the region of the gas generator and/or the gas conduit pipe. However, an arrangement of the air inlet can also be provided in the front or rear region of the missile.

The air inlet forms a gap in the region of its opening to the outer wall of the missile. The gap can extend annularly around the entire outer contour of the missile or affect only portions of the outer contour of the missile.

In the after-burner chamber, fuel is supplied to the supplied ambient air which is strongly heated by the compression in the compressor. The fuel is ignited, for example, at the start by means of spark plugs. The further combustion takes place continuously.

The exothermic reaction of the oxygen-hydrocarbon-mixture results in a further temperature increase and an expansion of the combustion gases. In the after-burning chamber, the expanded fuel gas is, coming from the turbine, combined with compressed air from the compressor and is caused to explode.

Under-balanced fuel gas, to which ambient air is supplied to, can burn completely.

The pressure prevailing in the after-burner chamber can be controlled by an adjustable plug nozzle. By way of example only and in no way exclusively, the combustion temperature can have a value of 2.500 K at a pressure of 4 to 15 bar.

The jet engine according to the invention proves to be particularly advantageous since until the time at which the fuel contained in the gas generator is completely consumed, an accidental extinction of the flame is merely impossible.

The spatial merging of the turbine with the compressing means increases the dynamics of the turbine-compressing means-unit, resulting in a substantially faster ramp-up time of the jet engine.

The optimized space utilization of the available space in the missile by the merging of the turbine and the compressing means in the turbine-compressing means-unit leads to space which is becoming empty. This space can be used e.g. for generation of electric energy, which, in turn, becomes noticeable in a further reduction in weight of the entire missile.

Since the jet engine according to the invention can provide thrust directly from the time of the ignition of the gas generator, the missile has an improved ability to rise off ground. Additionally, flight-mach numbers between 0.3 and 2.2 can be achieved already in the rise of ground-phase. In comparison thereto, mach numbers in the order of above 3 can be achieved with missiles according to the invention which are launched from an aircraft.

A further advantage is that the jet engine is very easy to control and the thrust curves achievable therewith allow acceleration- and deceleration phases following each other, whereby “holding patterns” for asymmetric scenarios in the flight envelope are possible.

Other advantages are that the parallel arrangement upstream of the turbine and the compressing means/compressor allow an extraordinary compact design. An additional extension of the space requirement of the engine is not required.

High energy, particle-loaded solid fuels can be used in the gas generator for generating gas bringing a significant increase in the level of performance with respect to the range and the thrust generation.

At the same time, the complexity of the engine design can be considerably simplified.

In a particularly advantageous embodiment, the turbine and the compressor are also designed as a unit. The turbine and the compressor are situated in a parallel arrangement, i.e. the hot gas flowing form the gas generator blows on the turbine blade.

At the same time, the turbine blade is connected with the compressor in a force-locked manner.

The connection between the turbine blade and the compressor is preferably effected by a race.

The arrangement of the turbine and the compressor is also preferred adjacent, however, substantially transverse to each other with respect to the direction of flight of the missile.

This has the advantage that an even shorter design can be achieved which involves next to a significant weight saving, in particular a volume saving. These are important aspects in missiles.

The active driving combustion or temperature increase takes place only after passing through the turbine and the compressor.

This even shorter construction allows to provide an embodiment of the unit consisting of turbine and compressor in which the compressor compresses the air trapped via the air inlet in a compressing ratio of two compared to its air content.

In this construction, therefore, two turbines and two compressors can be arranged one behind the other in the axial direction. This embodiment is advantageous if a compression ratio of two has to be realized since a single compressor stage which is not optimized does not allow such a compression ratio and, moreover, realizes only a compression ratio of about 1.4 is. In this case, it is advisable to switch two compressors in series, in order to realize the pressure increase factor of about 2.

In the last-mentioned embodiment it is a further aspect that the two stages operating then independently of each other, are counter-rotating, in order to realize a balanced momentum budget.

Moreover, the further described properties for the first embodiment are also valid for these further embodiments.

Further embodiments and examples will be described on the basis of the drawings. These are each showing schematically:

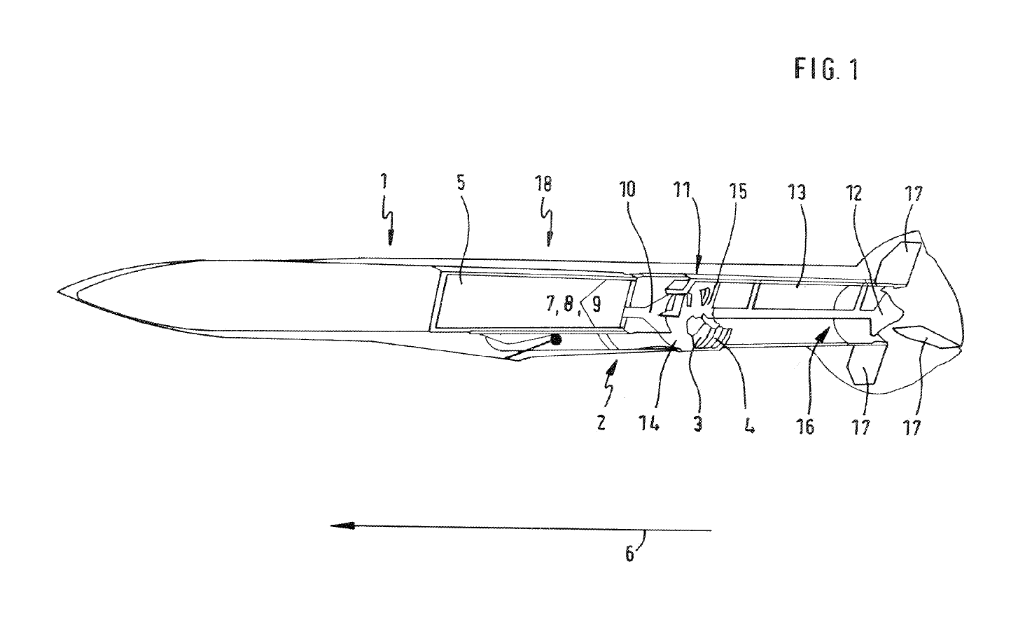

FIG. 1 the missile with gas generator, turbine-compressing means-unit and after-burner chamber in a longitudinal section

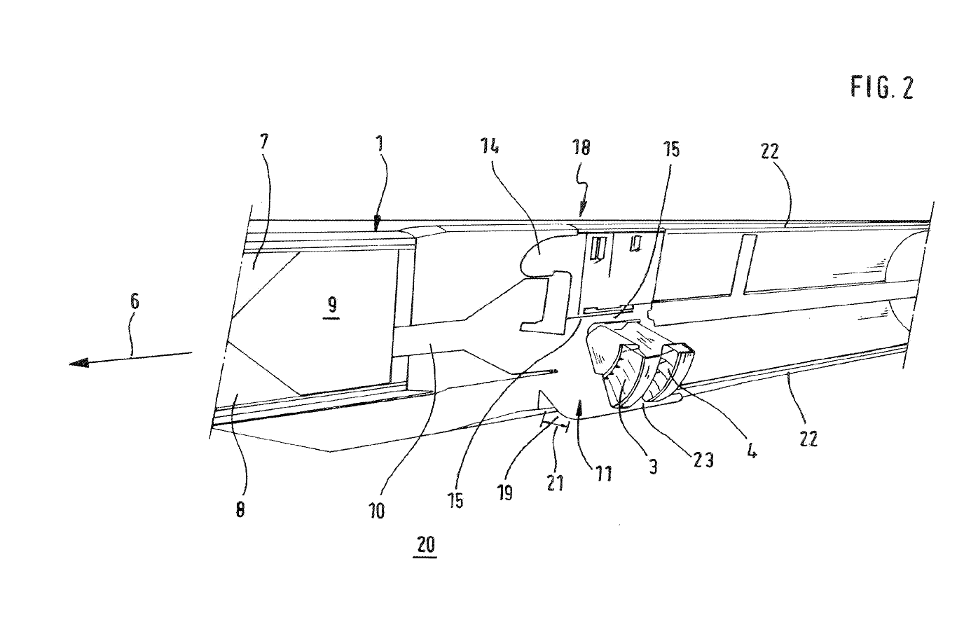

FIG. 2 in a detail of FIG. 1 the turbine-compressing means-unit,

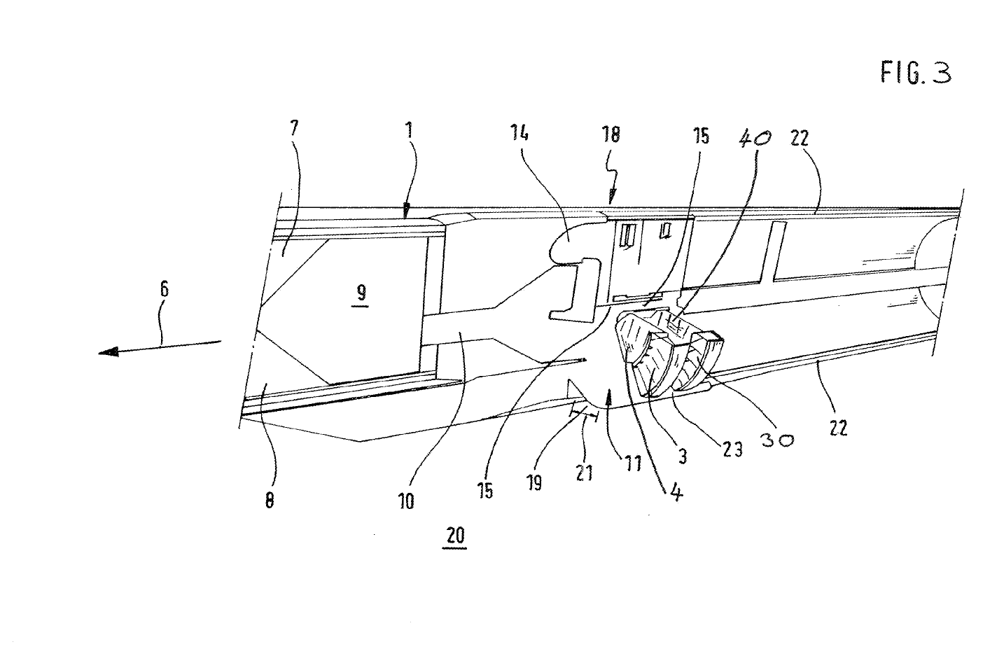

FIG. 3 in a detail of FIG. 1 the turbine-compressing means-unit in a parallel arrangement.

FIG. 1 shows a schematic representation of a missile 1 with a jet engine 2 comprising a turbine 3 and a compressing means 4 in the form of a compressor. In the front region of the missile 1 further aggrgates or units (not shown) as, for example, an explosive device, monitoring devices, sensors, cameras, etc. are accomodated.

Opposite to the direction of flight 6 of the missile 1, behind the front region 5, a gas generator 7 is shown comprising the solid fuel 8. At the rear end of the gas generator 7 an igniter 9 projects into the solid fuel 8. Subsequent to the gas generator 7 a gas conduit pipe 10 and a turbine-compressing means-unit 11 extend opposite to the direction of flight 6 behind the gas generator 7.

Between the turbine-compressing means-unit 11 and a nozzle 12 of the missile 1 an after-burner chamber 13 is arranged.

The gas conduit pipe 10 is funnel-shaped, wherein its diameter widens against the direction of flight 6 towards the turbine 3.

The turbine-compressing means-unit 11 is seated in a housing 14 which includes the turbine 3 and the compressing means 4.

In the axial extension of a drive shaft 15 on which the turbine 3 and the compressor 4 are arranged, the nozzle 12 is seated in the rear region 16 of the missile 1. In the region of the nozzle 12 baffles 17 are arranged. In the after-burner chamber 13, the air compressed and heated in the compressor 4 is supplied with fuel and the mixture is brought to explosion, whereby combustion gas is produced, which leaves the missile 1 through the nozzle 12 and causes the propulsion of the missile 1.

FIG. 2 shows as detail of FIG. 1 is a central region 18 of the missile 1 with the turbine-compressing means-unit 11. The turbine-compressing means -unit 11 includes the housing 14 and the drive shaft 15, on which axially one behind the other and adjacent to each other the 3 turbine and the compressing means/compressor 4 are arranged. Additional intermediate housing walls 23 effect a radial division of the housing 14 in a region which accommodates the turbine 3 and another region in which the compressor 4 is arranged.

The solid fuel 8 is ignited by the igniter 9 in the gas generator 7. The resulting combustion gas is through the gas conduit pipe 10 supplied to the turbine 3, which is arranged in the housing 14 of the turbine-compressing means-unit 11.

The combustion gas guided by means of the gas conduit pipe 10 rotates the turbine 3 around the drive shaft 15, which passes through the center of the turbine 3. The turbine 3 which is arranged adjacent to the compressor 4 drives the compressing means/compressor 4 and causes a rotation of the compressor 4 around the driving shaft 15.

Through an air inlet 19 ambient air 20 is supplied to the compressing means/compressor 4 and compacted by same.

The compressed ambient air 20 is, in the after-burner chamber 13, brought together with fuel (not shown) and caused to explode.

In the housing 14 of the turbine-compressing means-unit 11, the turbine 3 and the compressing means/compressor 4 are arranged with respect to the direction of flight 6 axially one behind the other.

The turbine 3 and the compressor 4 extend in the housing 14 of the turbine-compressing means-unit 11 in parallel.

Between the air inlet 19 and the outer shell 22 of the missile 1, a gap 21 is provided through which the ambient air 20 is penetrating into the air inlet 19 to be supplied to the compressor 4.

FIG. 3 shows as a detail of FIG. 1 a parallel arrangement of the turbine-compressing means-unit 11. The turbine 3 is connected to the compressing means/compressor 4. The connection is configured in a force-locked manner. The connection is established through a race. There is a parallel arrangement.

In an thereto parallel arrangement of the turbine-compressing means-unit, a turbine 30 and a compressing means/compressor 40 is arranged.

The turbine 3, 30 and the compressing means/compressor 4, 40 are connected adjacent and substantially transversely to the direction of flight of the missile, respectively, wherein the parallel arrangement of the turbine 30 and the compressing means/compressor 40 is arranged axially one behind the other respective to the turbine 3 and the compressing means/compressor 4.

This particularly space-saving and especially preferred adjacent arrangement of the turbine 3 and the compressing means/compressor 4 allows, therefore, a configuration such that the compressor compresses the air collected via the air inlet with a compression ratio of two for the contained air and supplys same then to a secondary reaction. This arrangement allows, as shown in the embodiment of FIG. 3, to use two compressors, in order to realize the desired pressure increase factor of two which is regularly not achieved in a single compression stage which is not optimized. By means of the two independently operating stages a counter-rotating arrangement takes place, in order to realize a balanced momentum budget.

The remaining components of this embodiment correspond to that of FIG. 2.

### REFERENCE NUMERALS

1 missile
2 jet engine
3 turbine
4 compressor
5 front region
6 direction of flight
7 gas generator
8 solid fuel
9 igniter
10 gas conduit pipe
11 turbine-compressing means-unit
12 nozzle
13 after-burner chamber
14 housing
15 drive shaft
16 rear region
17 baffle
18 central region
19 air inlet
20 ambient air
21 gap
22 outer shell of the missile
23 intermediate housing wall
30 turbine
40 compressor

1-14. (canceled)

15. A missile having a jet engine (2) comprising at least one turbine (3) and at least one compressing means (4), wherein gas generated in at least one gas generator (7) of the missile (1) drives at least one turbine (3), comprising the compressing means (4) and the turbine (3) arranged adjacent to each other.

16. Missile according to claim 15, the turbine (3) is opposite to the direction of flight (6), arranged axially in front of the compressing means (4).

17. Missile according to claim 15, the compressing means (4) is opposite to the direction of flight (6), arranged axially in front of the turbine (3).

18. Missile according to claim 15, the turbine (3) is connected to the compressing means (4).

19. Missile according to claim 18, the turbine (3) is connected to the compressing means (4) in a force-locked manner and being arranged substantially transversely to the direction of flight.

20. Missile according to claim 15, comprising a turbine (30) and a compressing means (40) arranged parallel to the turbine (3) and the compressing means (4).

21. Missile according to claim 15, the turbine (3) and the compressing means (4) form a spatial turbine-compressing means-unit (11) and are arranged in a common housing (14).

22. Missile according to claim 21, the turbine-compressing means-unit (11) is arranged in the front region (5) or in the rear region (16) or centrally (18) in the missile (1).

23. Missile according to claim 15, the compressing means (4) is a compressor.

24. Missile according to claim 15, the turbine (3) and the compressing means (4) are arranged on a common shaft (15).

25. Missile according to claim 15, comprising a gas conduit pipe (10) connected upstream configured to supply the gas to the turbine (3).

26. Missile according to claims 15, comprising an air inlet (19) connected upstream configure to supply ambient air (20) to the compressing means (4).

27. Missile according to claim 26, the air inlet (19) is arranged laterally at the missile (1) in the region of the gas generator (7) and/or the gas conduit pipe (10).

28. Missile according to claim 27, the air inlet (19) and the missile (1) having a gap extending therebetween.
